(19) United States
(12) Patent Application Publication
(10) Pub. No.: US 2026/0030186 A1
(43) Pub. Date: Jan. 29, 2026

(54) CONTACTLESS CONTROLLER AREA NETWORK (CAN) READER SYSTEMS AND METHODS

(71) Applicant: WHELEN ENGINEERING COMPANY INC., Chester, CT (US)

(72) Inventors: Paul Masi, JR., Middletown, CT (US); Tomasz Walczak, New Haven, CT (US)

(73) Assignee: WHELEN ENGINEERING COMPANY INC., Chester, CT (US)

(21) Appl. No.: 18/785,977

(22) Filed: Jul. 26, 2024

(51) Int. Cl. G06F 13/20

(52) U.S. Cl. CPC G06F 13/20; G06F 2213/40

(57) ABSTRACT

Systems and methods include a contactless controller area network (CAN) bus reader. The CAN bus reader may include a sensor and a decoder that extracts a signal from lines of the CAN bus, applies one or more operations to the signal, and determines a validity of a frame extracted from the signal. The decoder may include two separate evaluation branches that may operate, at least partially, in parallel to determine whether a given frame is a valid frame. The sensor and decoder may be stored in separate housing coupled together using a communication cable. At least a portion of the CAN bus may extend through a sensor housing associated with the sensor to permit a sensing element positioned within a threshold proximity to the portion of the CAN bus to extract a signal for further processing by the decoder.

### BACKGROUND

### 1. Field of Disclosure

Embodiments of the present disclosure relate to sensor configurations for communication systems. More particularly, systems and methods are directed toward a contactless controller area network (CAN) bus reader.

### 2. Description of Related Art

Automobiles may include a variety of different electronic devices which may include separate electronic control units (ECUs). A CAN bus may permit the various ECUs to communicate with one another using a message-based protocol without a central host computer. The CAN bus may be associated with a priority-based protocol that enables serial transmission of information that also applies an ordering hierarchy when messages are transmitted at the same time. It may be desirable to obtain information directly from the CAN, such as from the low/high wiring harness in vehicles, but obtaining this information may require cutting or otherwise connecting directly to the wires. This direct intervention may be undesirable and potentially has undesirable outcomes.

### SUMMARY

Applicant recognized the problems noted above herein and conceived and developed embodiments of systems and methods, according to the present disclosure, for proximity-based communication systems.

In an embodiment, a system for extracting a signal from a communication bus includes a sensor having a sensor housing and a decoder having a decoder housing. The sensor includes a sensing element configured to receive the signal from a pair of lines associated with the communication bus, the sensing element to be positioned within a threshold proximity of the pair of lines, wherein the sensing element is not physically coupled to the pair of lines. The sensor may also be configured to receive a signal from any number of lines, depending on the communication bus or other communication line being monitored. The sensor also includes a filtering stage positioned downstream of the sensing element, the filtering element removing one or more portions of the signal recovered by the sensing element. The filtering element may, for example, be a low-pass filter to reject noise. The sensor further includes an amplifier stage positioned downstream of the filtering stage, the amplifier stage configured to scale the signal, after the signal is filtered at the filtering stage, and prior to transmission from the sensor. The decoder includes a signal converter stage configured to convert the signal from a first type to a second type. The decoder also includes a signal processing stage configured to filter the signal after the signal is converted to the second type. The decoder further includes a decoding stage configured to extract a valid frame from the signal. The decoder also includes a transceiver configured to transmit the valid frame to an associated unit. The system also includes a communication cable extending between the sensor and the decoder.

The contactless controller area network (CAN) bus reader may further include a sensor having a sensor housing, the sensor housing including sensor processing electronics to extract, from a CAN bus, a signal without directly coupling to the CAN bus, the sensor being positioned within a threshold distance from the CAN bus to wirelessly extract the signal from a portion of the CAN bus positioned to extend through the sensor housing. The contactless CAN bus reader also includes a decoder having a decoder housing, separate from the sensor housing, including decoder processing electronics, the decoder processing electronics including a first frame recovery branch and a second frame recovery branch, configured for operation at least partially in parallel, to determine whether the signal includes a valid frame, wherein the decoder, upon determining the signal includes a valid frame from one or both of the first frame recovery branch or the second frame recovery branch, is configured to transmit the valid frame to a component that is not directly coupled to the CAN bus as a node.

In an embodiment, a method for recovering a frame from a controller area network (CAN) bus includes receiving, using a non-contact sensing element, a signal associated with the CAN bus. The method also includes removing one or more portions from the signal using one or more first filtering stages. The method further includes scaling the signal, after one or more first filtering stages, using an amplifier to create an amplified signal. The method also includes removing one or more portions from the amplified signal using one or more second filtering stages. The method includes extracting, after the one or more second filtering stages, a frame from the amplified signal. The method also includes determining the frame is a valid frame. The method further includes transmitting the frame along the CAN bus.

### BRIEF DESCRIPTION OF DRAWINGS

The present technology will be better understood on reading the following detailed description of non-limiting embodiments thereof, and on examining the accompanying drawings, in which:

FIG. 1 illustrates an environment for a controller area network (CAN) bus, in accordance with embodiments of the present disclosure;

FIG. 2 illustrates an example configuration for a contactless CAN bus reader, in accordance with embodiments of the present disclosure;

FIGS. 3A-3C illustrate example perspective views of a contactless CAN bus reader, in accordance with embodiments of the present disclosure;

FIG. 4 illustrates an example configuration for a sensor electronics package, in accordance with embodiments of the present disclosure;

FIG. 5 illustrates an example configuration for a decoder electronics package, in accordance with embodiments of the present disclosure;

FIG. 6 illustrates an example configuration for a decoding algorithm, in accordance with embodiments of the present disclosure;

FIG. 7 illustrates an example flow chart of a process for extracting a CAN frame, in accordance with embodiments of the present disclosure; and

FIG. 8 illustrates an example flow chart of a process for extracting a CAN frame, in accordance with embodiments of the present disclosure.

### DETAILED DESCRIPTION

The foregoing aspects, features, and advantages of the present disclosure will be further appreciated when considered with reference to the following description of embodiments and accompanying drawings. In describing the embodiments of the disclosure illustrated in the appended drawings, specific terminology will be used for the sake of clarity. However, the disclosure is not intended to be limited to the specific terms used, and it is to be understood that each specific term includes equivalents that operate in a similar manner to accomplish a similar purpose. Additionally, like reference numerals may be used for like components, but such use should not be interpreted as limiting the disclosure.

When introducing elements of various embodiments of the present disclosure, the articles “a”, “an”, “the”, and “said” are intended to mean that there are one or more of the elements. The terms “comprising”, “including”, and “having” are intended to be inclusive and mean that there may be additional elements other than the listed elements. Any examples of operating parameters and/or environmental conditions are not exclusive of other parameters/conditions of the disclosed embodiments. Additionally, it should be understood that references to “one embodiment”, “an embodiment”, “certain embodiments”, or “other embodiments” of the present disclosure are not intended to be interpreted as excluding the existence of additional embodiments that also incorporate the recited features. Furthermore, reference to terms such as “above”, “below”, “upper”, “lower”, “side”, “front”, “back”, or other terms regarding orientation or direction are made with reference to the illustrated embodiments and are not intended to be limiting or exclude other orientations or directions. Like numbers may be used to refer to like elements throughout, but it should be appreciated that using like numbers is for convenience and clarity and not intended to limit embodiments of the present disclosure. Moreover, references to “substantially” or “approximately” or “about” may refer to differences within ranges of +/−10 percent.

Embodiments of the present disclosure are directed toward a contactless controller area network (CAN) reader. Systems and methods may include a decoder housing and a sensor housing to extract information directly from the CAN bus and to process and transmit the extracted information. In at least one embodiment, the housings (e.g., the decoder housing and the sensor housing) are separate housings with independent mechanical and/or structural configurations that are coupled together via one or more communication cables (e.g., an interconnect communication cable). The communication cable may permit transmission of information between the housings. In at least one embodiment, the decoder housing is connected to external power and/or various associated units via one or more power cables and/or flying leads. Various embodiments include electronics packages positioned within the housings. For example, the decoder housing may include a decoder printed circuit board (PCB). The decoder housing may include a multi-part mechanical structure (e.g., a bottom housing, a top housing, etc.) that may be coupled together, such as via a snap-fitting or other method to permit access to the internals of the decoder housing. In at least one embodiment, the sensor housing includes a sensor PCB and may also include a multi-part mechanical structure. In at least one embodiment, one or more of the decoding housing and/or the sensor housing may include a gasket or seal. For the sensor housing, passages may be provided to receive the CAN HI and CAN LOW wires. Thereafter, a gasket associated with the sensor housing may be used to compress the CAN HI and CAN LOW wires extending through the openings.

Various embodiments provides a CAN bus reader that is split or divided into two separate mechanical and/or electrical systems, which may be coupled together to permit data and/or power communications. In at least one embodiment, the sensor housing may be associated with a sensor electrical package and the decoder housing may be associated with a decoder electrical package. The electrical packages may include various electronics and/or circuitry, such as those being part of a PCB assembly, and may further include various systems and/or sub-systems, as described herein. The interconnect cable may permit communication between the separate housings and, in at least one embodiment, the decoder housing may further be coupled to a control system, for example via the CAN bus. The sensor housing and associated electrical package may be tuned for a particular CAN bus network, but it should be appreciated that various embodiments may permit operation with a variety of different network configurations. By way of non-limiting example, the CAN bus network may have a bandwidth of 2 Megabytes per second (Mbps). This tuned signal may be amplified and transmitted to the decoder electrical package, for example using the interconnect cable. In at least one embodiment, the decoder electrical package may include one or more of an analog to digital converter (ADC), a digital signal processor (DSP), and/or additional electronics to support a variety of different CAN Frame reconstruction techniques. For example, the decoder electronics package may employ reconstruction techniques that look at the timing between pulses, including the timing between changing of the pulses. Even if there is noise in the message signal, the decoder electronics package can use reconstruction techniques to decode the message and run a check-sum to see if the message can be validated. The decoder electronics package may shift the timing for when the validation and reconstruction techniques are run, including, for example, trying lower bits if it is close to one end of a pulse or timing change.

In addition, the decoder electronics packager may enable error correction techniques to enhance reliability, such as by validating CAN Frames prior to transmission to one or more receiving units. Systems and methods may deploy error correction techniques where a cycle redundancy check (CRC) value is appended to ends of messages that may show, for example, bit flips. If there is no match, the system may try to flip certain bits at the end of the message to try to get the correct CRC value appended at the end. As a result, up to two bits of error correction may be enabled. Accordingly, embodiments of the present disclosure may be configured to retransmit reconstructed standard CAN frames up to a bandwidth of 2 Mbps. Furthermore, embodiments may also include one or more firmware or software packages that can be configurable by a control system. Such configurability may permit the decoder electronics package to extract relevant information from Flexible Data-Rate CAN frames (CAN-FD) and transmit the information onto a legacy CAN network that may not be compatible with CAN-FD.

Various embodiments of the present disclosure may include the sensor housing including the sensor electronics package. The sensor electronics package and/or the combination of the package the housing may also be referred to as a sensor in various embodiments and may include one or more components, elements, or sub-systems, such as a sensing element, a filter element, and an amplifier element. The sensing element may include one or more antennas, which may be positioned in near proximity (e.g., in contact with, within a threshold distance, etc.) of both the CAN High and the CAN Low wires. Furthermore, the filter element may include a low-pass filter to transmit information to the amplifier, thereby enabling the sensor to scale the received signal (e.g., the signal extracted via the sensing element) and reject and/or reduce noise.

Various embodiments of the present disclosure may include the decoder housing including the decoder electronics package. The decoder electronics package, and/or the combination of the package and the housing, may also be referred to as a decoder in various embodiments and may include one or more components, elements, or sub-systems such as an ADC, DSP, transceiver, and/or twisted pair connection, among various other options. The ADC may be used to sample a continuous-time signal and create a discrete signal for digital processing. The DSP may receive the signal and employ discrete filtering techniques to further process the signal before transmitting the signal into a CAN frame decoding algorithm, which may then be transmitted (as a decoded CAN frame) using the transceiver and twisted pair connection.

Systems and methods of the present disclosure may also incorporate one or more algorithms for CAN and CAN-FD reception. These algorithms may be deployed to execute as stored software instructions and/or may be executed using one or more modules configured to perform one or more steps of the algorithm. By way of example, one or more filter stages may be deployed, such as a first filter stage to remove high frequency noise and a second filter stage to remove low frequency noise. In at least one embodiment, one or both of the first and second filter stages may be adjustable filters. Additionally, there may be more or fewer stages. The filter stages may be incorporated to account for the amplified signal when processing high band rate CAN bus signals. One or more signal processing stages may also be incorporated within the algorithm, which may include stages such as a derivative block, a zero-crossing algorithm, one or more recovery algorithms, and/or one or more additional filters. For example, the derivative block may be used to approximate the derivative of an input signal with respect to a simulation time. The zero-crossing algorithm may be used to detect when a load has reached a zero-voltage point (e.g., detect when the incoming signal swaps polarities). Furthermore, the different recovery algorithms may be used to reconstruct CAN frames or a variety of other application to enhance system reliability. Moreover, in at least one embodiment, additional filtering or filtering coefficient algorithms may be deployed to tune or otherwise adjust one or more filters.

Systems and methods may include circuitry and/or algorithmic controls in order to permit frame reconstruction. For example, various embodiments may include one or more frame reconstruction modules to evaluate an input signal and determine whether there is a transmission to a recessive or dominant bit. Depending on the outcome, the zero-crossing algorithm may be used to continue to evaluate the input to provide a parallel system for frame recovery, as described herein. For example, a failure at the module may default to frame recovery using the derivative block and/or zero-crossing algorithm. However, if both processes recover the frame, then each may be evaluated to determine the same result is achieved within a threshold quantity. If there is sufficient CRC matching from one or both processes, then it may be determined within a threshold level of confidence that the frame is recovered. A recovered frame may then be transmitted. However, unvalidated frames may not be transmitted to reduce a likelihood of driver saturation.

Systems and methods may provide a compact, robust, and reliable system for logging data from a CAN bus. Various embodiments provide one or more housings that include sensors and decoders to extract a signal from the CAN L/H writing harness, process the signal, and then transmit validated signals to one or more end users. Such a system may be configured to extract signals from the writing harness without splicing or otherwise cutting into the wire itself, and instead, may use one or more sensing elements and processing techniques in order to acquire the log data.

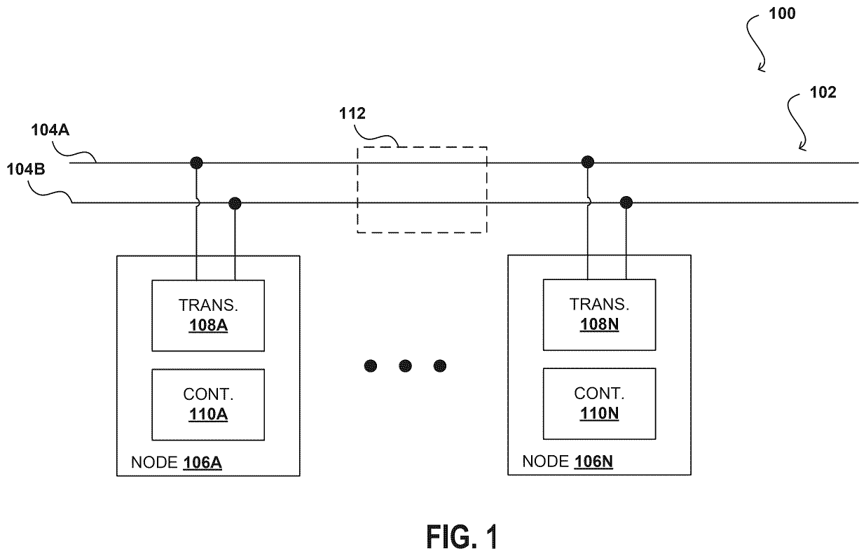

FIG. 1 illustrates an example environment 100 that may be used with embodiments of the present disclosure. In this example, the environment 100 is associated with a CAN bus of a vehicle, but it should be appreciated that various systems and methods may be adapted for and used with a variety of applications in which contactless sensing and data evaluation may be desirable. In this example, a CAN bus 102 includes a CAN High line 104A (e.g., CANH, CAN-H, CAN HIGH) and a CAN Low line 104B (e.g., CANL, CAN-L, CAN LOW). As noted, the CAN bus 102 may be used in a variety of systems, such as automobiles, to enable communication between different electronic components via one or more ECUs that are commonly connected to the CAN bus 102.

In operation, the CAN bus 102 may use the CAN Protocol to transmit information (e.g., messages) across a network of nodes 106 connected through the CAN bus 102. As shown, the nodes 106A-106N include a variety of systems and/or sub-systems such as transceivers 108A-108N and controllers 110A-110N. In various embodiments, the controllers 110A-110N may be representative of a group of control units, which may include a microcontroller unit, a CAN controller, and/or the like. For example, the CAN controller may include one or more chips or collections of circuitry to manage and send data via the transceivers 108A-108N. In operation, the CAN protocol is used to send and receive messages using unique identifiers (IDs) for each message. Transmitted data packets are received by all nodes 106A-106N in the CAN bus network, but depending on the ID, individual CAN nodes decide whether or not to accept a given packet of data. CAN protocol follows the arbitration process when multiple nodes try to send data at the same time such that higher priority signals are processed first.

CAN signals may be single-ended signals and differential signals according to the line of transmission. Generally, CAN High and CAN Low lines 104A, 104B are at 2.5V. Thereafter, different bits are associated with different voltages through the lines 104A, 104B, with “zero” being a dominant bit and “one” being a recessive bit. When the dominant bit is transmitted, the CAN High line 104A goes to 3.5V and the CAN Low line 104B goes to 1.5V. In other words, the differential voltage is 2V for the dominant bit. Similarly, when the recessive bit is transmitted, the CAN High line 104A goes to 2.5V and the CAN Low line 104B goes to 2.5V, indicating a differential voltage of 0V for the recessive bit.

As noted herein, the CAN protocol may also include different frame types, which may include data frames, remote frames, error frames, and/or overload frames. A frame is a defined structure or format that carries meaningful data (e.g., bytes) within the network. For example, a data frame may carry actual data for transmission. It may be desirable to receive information from the CAN bus, but adding additional nodes 106 may be prohibitively expensive and/or difficult. Accordingly, systems and methods of the present disclosure are directed toward a contactless CAN reader 112 that may be implemented to extract signals from the CAN bus 102 without directly connecting to the line 104A, 104B. In this manner, data can be obtained from the CAN bus 102 and provided to one or more third party applications or loggers without directly splitting or otherwise connecting to the line 104A, 104B.

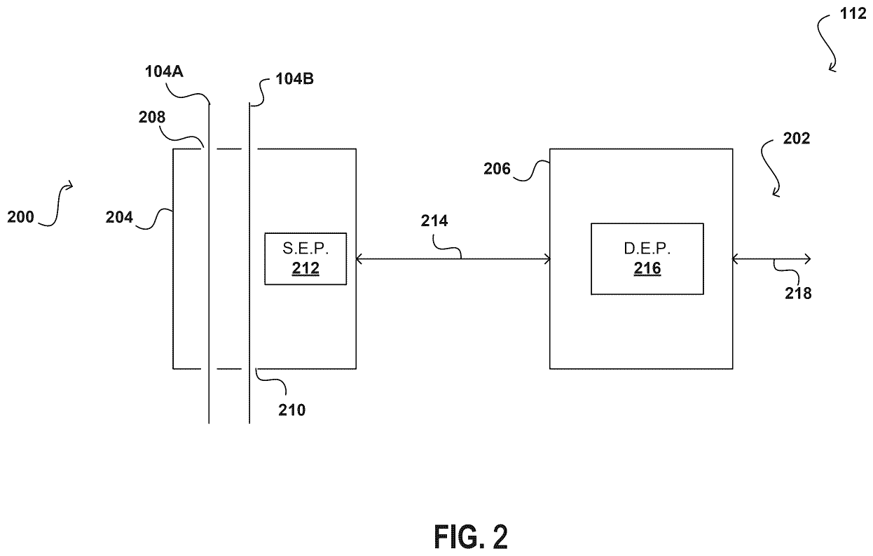

FIG. 2 illustrates an example embodiment of the CAN bus reader 112 that may be used with embodiments of the present disclosure. In this example, the CAN bus reader 112 is divided into two components, which may be referred to as a sensor 200 and a decoder 202. In at least one embodiment, each of the sensor 200 and the decoder 202 are physical components that may include separate housings 204, 206. A first housing 204 may also be referred to as the sensor housing 204, while a second housing 206 may be referred to as the decoder housing 206. Each housing 204, 206 may include one or more components or portions, such as a top portion or a bottom portion, that permits access to an interior of housings 204, 206. The top and bottom portions may be coupled together, such as by a hinge to allow a top portion to rotate about the hinge, thereby providing access to the interior portion. Furthermore, various embodiments may include top and bottom portions that are not coupled together unless they are secured using one or more fasteners and/or other methods for attaching different parts together.

In this example, the sensor housing 204 includes a first opening 208 and a second opening 210 through which the lines 104A, 104B extend. For example, a top portion of the sensor housing 204 may rotate open to permit the lines 104A, 104B to be positioned through the openings 208, 210. Thereafter, the top portion may be closed and compressed against the lines 104A, 104B, which may position portions of a sensor electronics package 212 in close proximity to the lines 104A, 104B, thereby permitting the sensor 200 to receive information from the CAN bus without splicing or otherwise directly coupling to the lines 104A, 104B.

The sensor housing 204 is coupled to the decoder housing 206 via an interconnect cable 214, which permits data and/or power transmission between the sensor 200 and the decoder 202. The decoder 202 includes a decoder electronics package 216, which as noted herein may include one or more systems and/or sub-systems to facilitate filtering, processing, and/or transmission of signals obtained via the sensor 202. Moreover, in this example, a cable 218 extends from the decoder housing 206 to provide eternal power to the system 112 and/or to facilitate communication with one or more associated units.

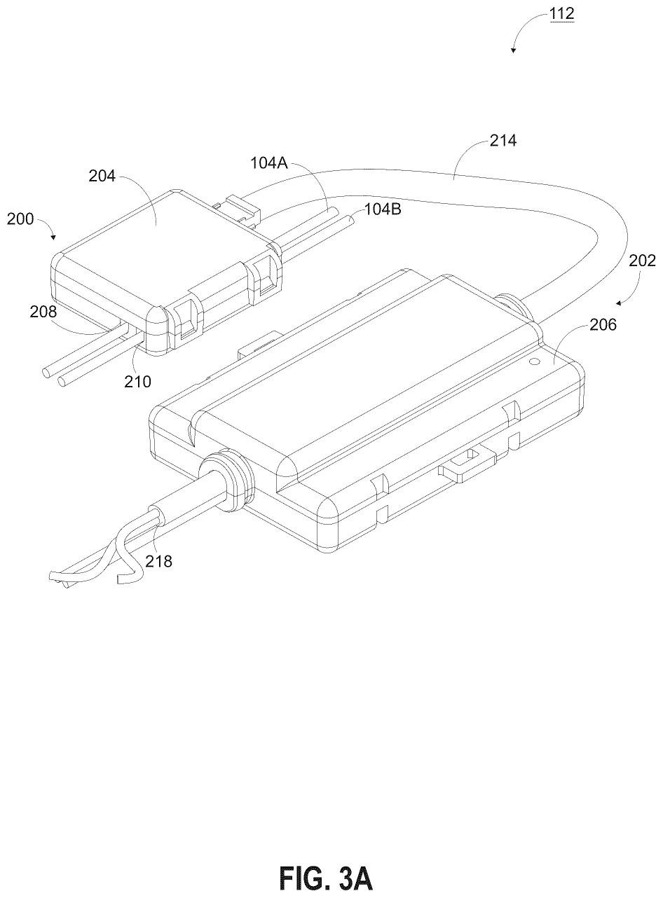

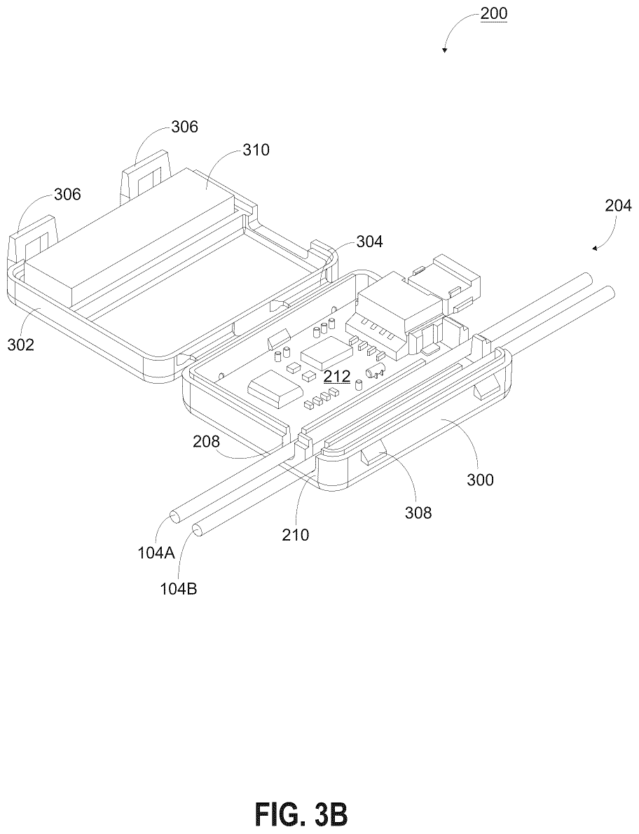

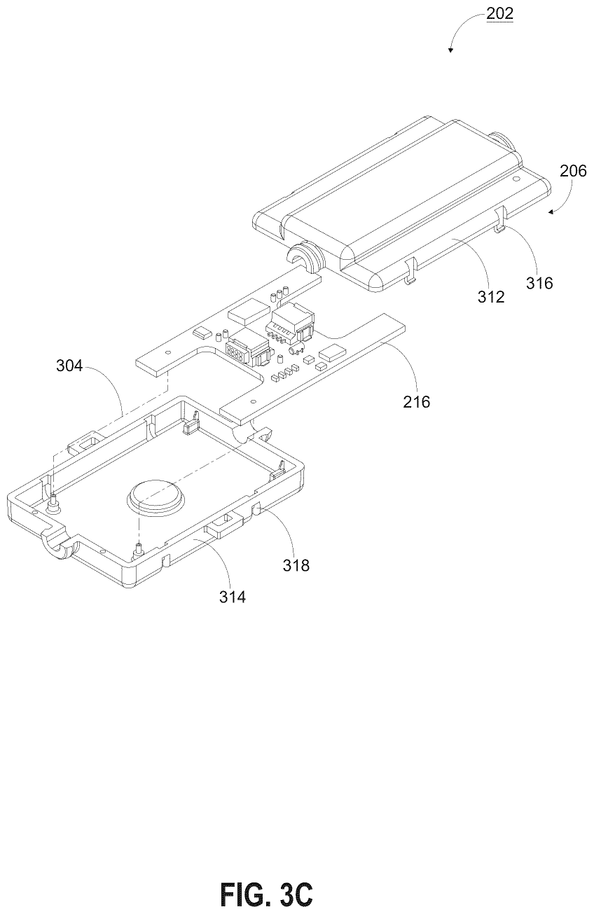

FIG. 3A illustrates an example perspective view of an embodiment of the CAN bus reader 112 that may incorporate features described herein. In this example, each of the sensor 200 and the decoder 202 are illustrated as being separate modules coupled together via the cable 214. Each further includes separate housings 204, 206, which may be operational to enable portions to open/close, for example at a hinge or via one or more press-fit connections, among various other potential configurations. As shown, the sensor housing 204 includes the openings 208, 210 that permit the lines 104A, 104B to extend through the sensor housing 204, which as described herein, may position one or more sensing elements in proximity to the lines 104A, 104B to enable identification of signals without directly coupling to the lines 104A, 104B.

FIG. 3B illustrates an example perspective view of an embodiment of the sensor 200 where the sessor housing 204 is in an open position to illustrate an interior portion. In this example, the sensor housing 204 includes a bottom portion 300 and a top portion 302, but as noted, the terms “top” and “bottom” are provided as an example for clarity with the illustrated embodiment and are not intended to limit the scope of the present disclosure. The illustrated openings 208, 210 are shown within the bottom portion 300 in FIG. 3B, but other embodiments may position the openings 208, 210 within the top portion 302 and/or include a portion of the openings 208, 210 within the top portion 302 and/or the bottom portion 300.

Further illustrated is the sensor electronics package 212, which may include a PCB assembly that has one or more components such as sensing elements, amplifiers, filters, and/or the like. The electronics package 212 may be secured to the bottom portion 300 and then positioned within a threshold distance of the lines 104A, 104B to permit detection of signals using one or more sensing elements, such as an antenna.

The illustrated top portion 302 is rotationally coupled to the bottom portion 300 via a hinge 304, but other embodiments may omit the hinge 304 in favor of a variety of coupling tools and/or devices to facilitate coupling and then disconnecting the top portion 302 and the bottom portion 300. In this example, fasteners 306 are included on the top portion 302 that engage mating fasteners 308 of the bottom portion to secure the top portion 302 to the bottom portion 300 and to drive a gasket 310 against the lines 104A, 104B.

FIG. 3C illustrates an example exploded perspective view of an embodiment of the decoder 202 where the decoder housing 206 is open to illustrate an interior portion. In this example, the decoder electronics package 216 may be positioned within the interior portion. The housing 206 includes a top portion 312 and a bottom portion 314. As noted with respect to the sensor housing 204, the housing 206 illustrates an embodiment where there is no hinge and the top and bottom portions 312, 314 are fully separated from one another. In this example, fasteners 316 and mating fasteners 318 are used to secure the top portion 312 to the bottom portion 314.

Systems and methods of the present disclosure may be directed toward a CAN bus reader 112 that includes one or more systems or sub-systems to enable contactless receipt of various transmitted signals. In at least one embodiment, one or more PCBs may be used to house different electronics package 212, 216 to enable sensing, filtering, transmission, and decoding of various messages associated with a CAN bus. The sensor 200 may be tuned for a CAN bus network having a particular bandwidth, but as noted herein, may also be adjustable to work with a variety of different networks. A tuned signal may be received and amplified prior to being provided to the decoder 202, which may deploy a variety of construction techniques in order to reconstruct a CAN frame and transmit information to a receiving unit.

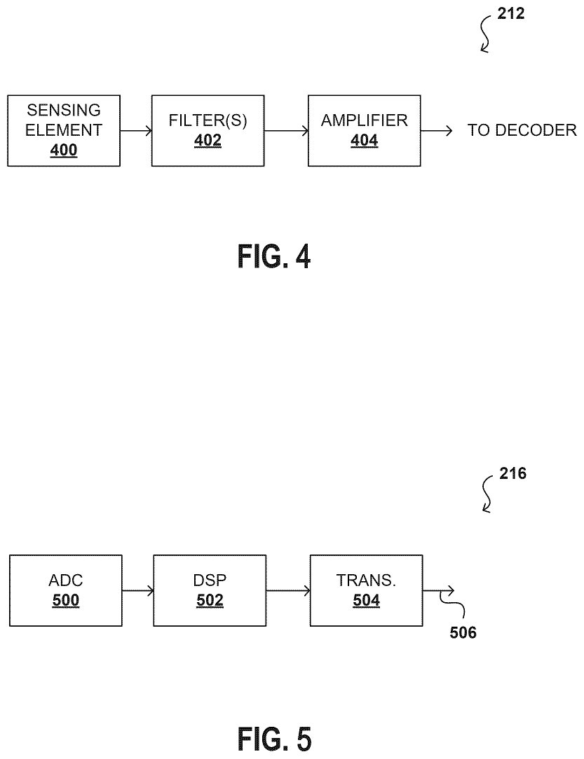

FIG. 4 illustrates an example embodiment of the sensor electronics package 212. It should be appreciated that various features have been removed for clarity and conciseness and that additional systems and/or sub-systems may be included, for example supporting systems to facilitate power transmission, data communications, and/or the like. In this example, a sensing element 400 is positioned to receive information from the lines 104A, 104B. For example, the sensing element 400 may include one or more antenna, which may be tuned for a particular CAN bus configuration, that are positioned within a threshold proximity of the lines 104A, 104B extending through the sensor housing 204. The sensing element 400 may acquire the signal and provide the signal to one or more filters 402, such as various low-pass filters. The low-pass filter may be used to reduce noise within the signal obtained via the sensing element 400. An amplifier 404 may then be used to scale the received signal for transmission to the decoder 202.

FIG. 5 illustrates an example embodiment of the decoder electronics package 216. As noted herein, various components have been removed and/or simplified for clarity with the following discussion. In this example, a signal converter 500 is included within the electronics package, which may be an ADC. The ADC may be configured to sample the continuous-time signal and create a discrete signal for digital processing via one or more signal processors 502. For example, in examples where the converter 500 is the ADC, the signal processor 502 may be a DSP that employs one or more discrete filtering techniques to further process the signal before being transmitted to one or more decoding algorithms, as noted herein. The decoded CAN frame may then be transmitted using a transceiver 504, for example via a twisted pair connection 506. In this manner, the sensor 200 may be used to acquire the signal from the lines 104A, 104B and then the decoder 202 may be used to decode and transmit the signal for use without directly coupling to the lines 104A, 104B.

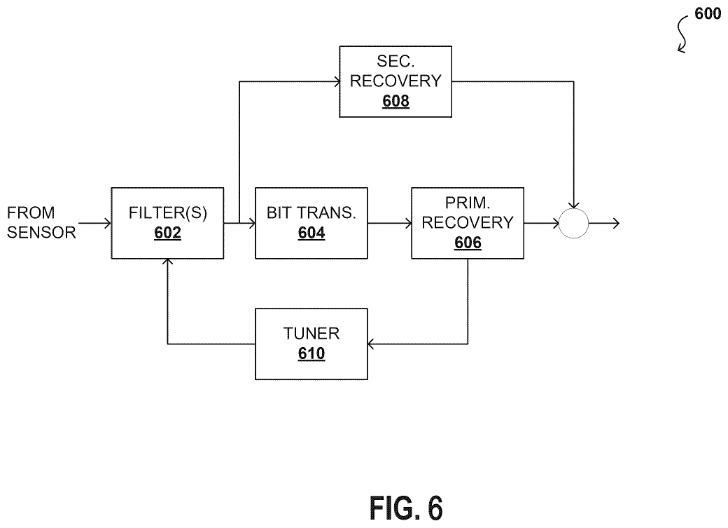

FIG. 6 illustrates illustrate an example algorithmic flow diagram 600 that may be used with embodiments of the present disclosure. In this example, an input signal is received from the sensor 202 at one or more filtering stages 602. For example, the filtering stages 602 may include multiple filters, such as a digital low pass filter to remove high frequency noise and also a filter to remove low frequency noise, such as low frequency components generated by the amplifier circuit when processing high band rate CAN bus signals. In at least one embodiment one or more filtering stages may be static and/or adjustable. An output from the filter stages 602 may be provided along two different branches of the algorithm, as shown in FIG. 6. For example, along a first branch, a bit transition module 604 may be used to show recessive or dominant bit transformation. In at least one embodiment, the bit transition module 604 may include one or more systems or sub-systems, such as a derivative block and/or a zero-cross module, as noted herein. The derivative block may determine a derivative of an input signal with respect to simulation time and the zero-cross module may be used to identify a point when a zero load point is reached, indicating transitions between recessive and/or dominant bits. The output of the bit transition module 604 may be processed by a primary recovery algorithm 606 that is used to reconstruct the CAN frame.

The second branch is illustrated as using a secondary recovery algorithm 608, which may enhance system reliability. For example, the secondary recovery algorithm 608 may be configured to evaluate a level of an incoming signal to determine whether the signal is transitioning to a recessive or dominant bit. Output from each of the recovery algorithms 606, 608 may then be compared and/or evaluated to determine which frame to transmit. In at least one embodiment, each of the first and second branches may operate in parallel where, if one branch fails, the result of the other branch may be accepted. If both branches identify a result, a comparer may be used to evaluate whether each result is within a threshold of another. That is, if both recover the frame, then each recovered frame can be used as a check to make sure both got the same result (e.g., a result within a threshold level of confidence). However, if only one branch recovers, and has CRC match, then systems and methods still provide a level of confidence regarding the recovered frame. In at least one embodiment, only recovered, valid frames are sent along the CAN bus and invalid frames and/or corrupted frames are not transmitted. Various embodiments may deploy just the first branch, just the second branch, or both the first and second branch.

As noted herein, various embodiments may include one or more tunable filters within the filter stages 602. For example, a tuner 610 may receive information from the primary recovery module 606 and then adjust weights or parameters of the filters in order to provide feedback to increase recovery and reliability.

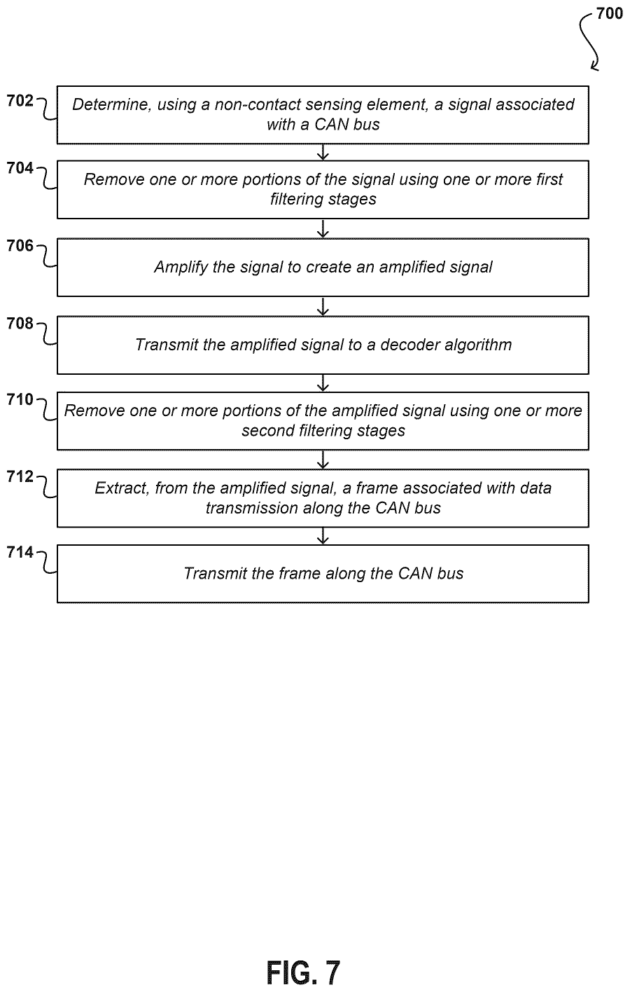

FIG. 7 is a flow chart of a method 700 for recovering and validating a frame from a CAN bus. It should be appreciated that steps for the method may be performed in any order, or in parallel, unless otherwise specifically stated. Moreover, the method may include more or fewer steps. In this example, a non-contact sensing element is used to determine a signal associated with a CAN bus 702. The signal may be a message transmitted from one or more ECUs for an associated component and/or note of the CAN bus, such as an electrical component within an automobile, among various other options. The non-contact sensor may include one or more antennas that are positioned within a threshold proximity of a CAN-H and/or CAN-L line in order to extract signal information without directly coupling to the lines. One or more portions of the signal extracted from the bus may be removed using one or more first filtering stages 704. For example, a low-pass filter may be used to remove noise. Additional filtering stages may also be applied and, in certain embodiments, one or more filtering stages may be tunable. The signal may be amplified to create an amplified signal 706. For example, an amplifier may be part of a sensor electronics package that boosts or otherwise scales the signal prior to transmission to one or more decoders, as described herein.

The amplified signal may be transmitted to a decoder for processing via a decoder algorithm 708. For example, a communication cable may couple the sensor and/or portions thereof to one or more decoders, which may include circuitry that corresponds to a decoder algorithm. The decoder algorithm may be in the form of one or more executable computer programs stored on a memory to process one or more signals, which may be a digital signal, a converted analog signal, and/or combinations thereof. Furthermore, the decoder algorithm may refer to one or more components, systems, or sub-systems that are coupled together to execute a particular function. For example, the decoder algorithm may include components for filtering, derivative blocks, zero-crossing determinations, frame recovery, tuning, and/or the like.

One or more portions of the amplified signal may be removed using one or more filtering stages 710. For example, a first filtering stage may correspond to a digital low pass filter to remove high frequency noise and a second filtering stage may correspond to an adjustable filter, which may be tuned or otherwise adjusted, to remove low frequency components. Various embodiments provide different filtering stages that can be tuned or adjusted via one or more controllers, for example, based on a desired operating parameter and/or to accommodate a particular type of signal, among other options. The amplified signal may be processed to extract a frame associated with data transmission along the CAN bus 712. For example, it may be desirable to extract a valid frame, which may correspond to a message considered to be error free when a last bit is received in an error-free recessive state. The validated frame may then be transmitted to a specified endpoint along the CAN bus 714. In this manner, signals may be extracted and transmitted from the CAN bus without forming a direct physical connection to the CAN lines.

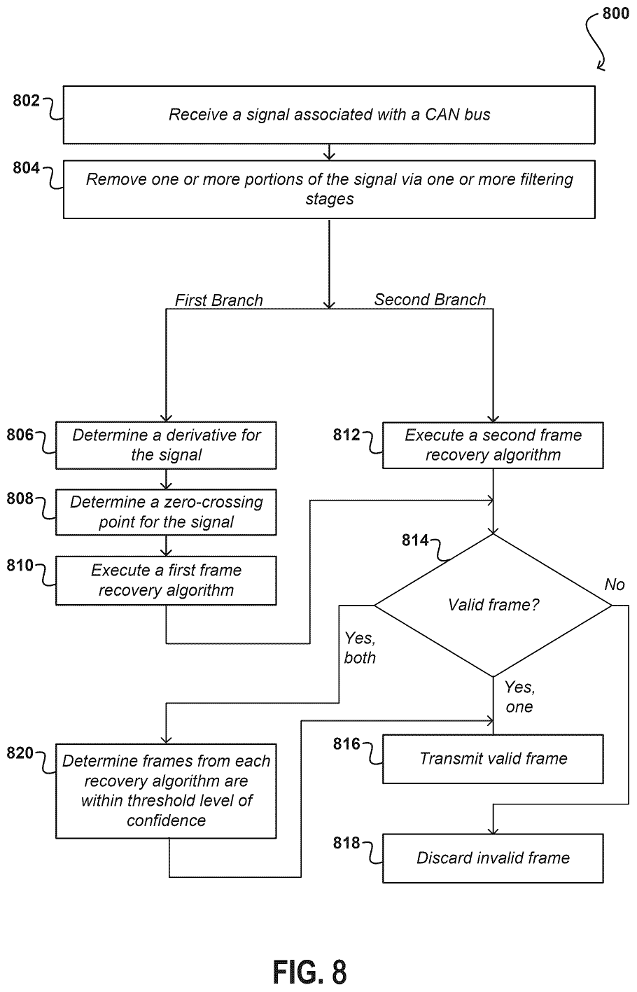

FIG. 8 illustrates an example flowchart for a method 800 for recovering a frame extracted using a non-contact CAN bus reader. In this example, a signal may be received that is associated with a CAN bus 802, such as using a reader as described herein. The signal may undergo one or more pre-processing steps. For example, one or more portions may be removed using one or more filtering stages 804. Thereafter, systems and methods may include multiple different branches for processing and/or recovering frames from the signal. In this example, a first branch is associated with a recovery algorithm that may include determining a derivative for the signal 806, determining a zero-crossing point for the signal 808, and executing a first frame recovery algorithm 810. A second branch may also execute, for example at least partially in parallel with the first branch, to execute a second frame recovery algorithm on the signal 812.

It may be determined whether a valid frame has been recovered 814. The determination may involve evaluation of outputs from both the first branch and the second branch, but as noted herein, various embodiments may eliminate the first branch or the second branch. If a valid frame is recovered, the frame may transmitted 816. If no valid frame is recovered, then the invalid frame may be discharged 818. If valid frames are determined for both the first and second branches, then the frames may be compared to determine that similarities within a threshold confidence level 820, and then may be transmitted 816. In this manner, more robust processing can be deployed by performing additional checking after executing the different recovery algorithms.

Although the technology herein has been described with reference to particular embodiments, it is to be understood that these embodiments are merely illustrative of the principles and applications of the present technology. It is therefore to be understood that numerous modifications may be made to the illustrative embodiments and that other arrangements may be devised without departing from the spirit and scope of the present technology as defined by the appended claims.

1. A system for extracting a signal from a communication bus, comprising:
a sensor having a sensor housing, the sensor comprising:
a sensing element configured to receive the signal from a pair of lines associated with the communication bus, the sensing element to be positioned within a threshold proximity of the pair of lines, wherein the sensing element is not physically coupled to the pair of lines;
a filtering stage positioned downstream of the sensing element, the filtering element removing one or more portions of the signal recovered by the sensing element; and
an amplifier stage positioned downstream of the filtering stage, the amplifier stage configured to scale the signal, after the signal is filtered at the filtering stage, and prior to transmission from the sensor;
a decoder having a decoder housing, the decoder comprising:
a signal converter stage configured to convert the signal from a first type to a second type;
a signal processing stage configured to filter the signal after the signal is converted to the second type;
a decoding stage configured to extract a valid frame from the signal; and
a transceiver configured to transmit the valid frame to an associated unit; and
a communication cable extending between the sensor and the decoder.

2. The system of claim 1, wherein the first type is an analog signal and the second type is a digital signal.

3. The system of claim 1, wherein the sensing element includes one or more antennas.

4. The system of claim 1, wherein the sensor housing further comprises:
a top portion;
a bottom portion; and
one or more openings formed in at least one of the top portion or the bottom portion;
wherein the pair of lines are configured to extend through the one or more openings such that when the top portion is coupled to the bottom portion the pair of lines are positioned within the threshold proximity of the sensing element.

5. The system of claim 1, wherein the decoding stage further comprises:
a first branch including a derivative block, a zero-cross algorithm, and a first frame recovery algorithm; and
a second branch including a second frame recovery algorithm.

6. The system of claim 5, wherein the first branch and the second branch are executed at least partially in parallel.

7. The system of claim 1, wherein the signal processing stage comprises:
a digital low pass filter; and
an adjustable low frequency filter.

8. The system of claim 6, wherein the adjustable low frequency filter is tunable based, at least in part, on a signal received from a control system.

9. The system of claim 1, further comprising:
a control system configured to adjust one or more operating parameters of at least one of the sensor or the decoder; and
a second cable extending between the control system and the decoder.

10. A contactless controller area network (CAN) bus reader, comprising:
a sensor having a sensor housing, the sensor housing including sensor processing electronics to extract, from a CAN bus, a signal without directly coupling to the CAN bus, the sensor being positioned within a threshold distance from the CAN bus to wirelessly extract the signal from a portion of the CAN bus positioned to extend through the sensor housing; and
a decoder having a decoder housing, separate from the sensor housing, including decoder processing electronics, the decoder processing electronics including a first frame recovery branch and a second frame recovery branch, configured for operation at least partially in parallel, to determine whether the signal includes a valid frame, wherein the decoder, upon determining the signal includes a valid frame from one or both of the first frame recovery branch or the second frame recovery branch, is configured to transmit the valid frame to a component that is not directly coupled to the CAN bus as a node.

11. The contactless CAN bus reader of claim 10, wherein the sensor housing further comprises:
a top portion;
a bottom portion, wherein the top portion is rotatably coupled to the bottom portion via a hinge element;
a fastener coupled to the top portion; and
a mating fastener coupled to the bottom portion, wherein the fastener engages the mating fastener to secure the top portion to the bottom portion.

12. The contactless CAN bus reader of claim 10, wherein the sensor processing electronics include at least one or more of a sensing element, a filter, and an amplifier.

13. The contactless CAN bus reader of claim 12, wherein the sensing element is an antenna.

14. The contactless CAN bus reader of claim 10, wherein the decoder processing electronics include at least one or more of a signal converter, a signal processor, a decoding algorithm, and a transceiver.

15. The contactless CAN bus reader of claim 14, wherein the signal converter is an analog to digital converter and the signal processor includes at least two filter stages including a low pass filter and an adjustable filter.

16. The contactless CAN bus reader of claim 10, further comprising:
a control system coupled to the decoder, the control system adjusting one or more operating parameters of at least one of the decoder or the sensor to extract information from a flexible data-rate CAN protocol and convert the extracted information to use with one or more systems that are not compatible with the flexible data-rate CAN protocol.

17. A method for recovering a frame from a controller area network (CAN) bus, comprising:
receiving, using a non-contact sensing element, a signal associated with the CAN bus;
removing one or more portions from the signal using one or more first filtering stages;
scaling the signal, after one or more first filtering stages, using an amplifier to create an amplified signal;
removing one or more portions from the amplified signal using one or more second filtering stages;
extracting, after the one or more second filtering stages, a frame from the amplified signal;
determining the frame is a valid frame; and
transmitting the frame along the CAN bus.

18. The method of claim 17, further comprising:
processing, after the one or more second filtering stages, the amplified signal along a first branch; and
processing, after the one or more second filtering stages and at least partially in parallel with the first branch, the amplified signal along a second branch.

19. The method of claim 18, wherein the first branch includes a first recovery algorithm and the second branch includes a second recovery algorithm.

20. The method of claim 18, wherein the determining of the valid frame is based, at least in part, on an output of at least one of the first branch or the second branch.
